(19) United States
(12) Patent Application Publication
(10) Pub. No.: US 2020/0120120 A1
(43) Pub. Date: Apr. 16, 2020

(54) TECHNIQUES FOR NETWORK INSPECTION FOR SERVERLESS FUNCTIONS

(71) Applicant: Nuweba Labs Ltd., Tel Aviv-Jaffa (IL)

(72) Inventor: Yan CYBULSKI, Tel-Aviv (IL)

(73) Assignee: Nuweba Labs Ltd., Tel Aviv-Jaffa (IL)

(21) Appl. No.: 16/598,448

(22) Filed: Oct. 10, 2019

Related U.S. Application Data
(60) Provisional application No. 62/744,099, filed on Oct. 10, 2018.

(51) Int. Cl. H04L 29/06

(52) U.S. Cl. CPC H04L 63/1425; H04L 63/1416; H04L 63/0281; H04L 63/20

(57) ABSTRACT

A system and method for providing network security for serverless functions. The method includes inspecting network traffic between a pod and at least one network, wherein the pod is an instance of a software container configured to execute at least one serverless function, wherein each serverless function accesses at least one service via the at least one network; detecting a violation of a network profile created for each of the at least one serverless function based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and performing at least one mitigation action when the violation is detected.

### CROSS-REFERENCE TO RELATED APPLICATIONS

This application claims the benefit of U.S. Provisional Application No. 62/744,099 filed on Oct. 10, 2018, the contents of which are hereby incorporated by reference.

### TECHNICAL FIELD

The present disclosure relates generally to cloud computing services, and more specifically to securing function as a service (FaaS) platforms.

### BACKGROUND

Organizations have increasingly adapted their applications to be run from multiple cloud computing platforms. Some leading public cloud service providers include Amazon®, Microsoft®, Google®, and the like. Serverless computing platforms provide a cloud computing execution model in which the cloud provider dynamically manages the allocation of machine resources. Such platforms, also referred to as function as a service (FaaS) platforms, allow execution of application logic without requiring storing data on the client's servers. Commercially available platforms include AWS Lambda by Amazon®, Azure® Functions by Microsoft®, Google Cloud Functions Cloud Platform by Google®, OpenWhisk by IBM®, and the like.

“Serverless computing” is a misnomer, as servers are still employed. The name “serverless computing” is used to indicate that the server management and capacity planning decisions of serverless computing functions are not managed by the developer or operator. Serverless code can be used in conjunction with code deployed in traditional styles, such as microservices. Alternatively, applications can be written to be purely serverless and without using provisioned services at all.

Further, FaaS platforms do not require coding to a specific framework or library. FaaS functions are regular functions with respect to programming language and environment. Typically, functions in FaaS platforms are triggered by event types defined by the cloud provider. Functions can also be trigged by manually configured events or when a function calls another function. For example, in Amazon® AWS®, such triggers include file (e.g., S3) updates, passage of time (e.g., scheduled tasks), and messages added to a message bus. A programmer of the function would typically have to provide parameters specific to the event source it is tied to.

A serverless function is typically programmed and deployed using command line interface (CLI) tools, an example of which is a serverless framework. In most cases, the deployment is automatic and the function's code is uploaded to the FaaS platform. A serverless function can be written in different programming languages, such as JavaScript®, Python®, Java®, and the like. A function typically includes a handler (e.g., handler.js) and third-party libraries accessed by the code of the function. A serverless function also requires a framework file as part of its configuration. Such a file (e.g., serverless.yml) defines at least one event that triggers the function and resources to be utilized, deployed or accessed by the function (e.g., database).

Some serverless platform developers have sought to take advantage of the benefits of software containers. For example, one of the main advantages of using software containers is the relatively fast load times as compared to virtual machines (VMs). However, while load times such as 100 ms may be fast as compared to VMs, such load times are still extremely slow for the demands of FaaS infrastructures.

FIG. 1 shows an example diagram 100 illustrating a FaaS platform 110 providing functions to various services 120-1 through 120-6 (hereinafter referred to as services 120 for simplicity). Each of the services 120 may utilize one or more of the functions provided by software containers 115-1 through 115-4 (hereinafter referred to as a software container 115 or software containers 115 for simplicity). Each software container 115 receives requests from the services 120 and provides functions in response. To this end, each software container 115 includes code of its respective function. When multiple requests for the same software container 115 are received around the same time, a performance bottleneck occurs.

One vulnerability in ephemeral execution environments is caused by the way in which functions are invoked. The ephemeral execution provides, on each execution, a clean environment without any changes that can occur after execution of code begins in order to avoid unexpected bugs or problems due to residual changes. However, providing ephemeral execution environments requires running servers for a prolonged period of time. Some FaaS providers offer environment reuse (container reuse) to compensate for high cold start time (or warm start). However, such reuse poses a risk since the software container maintains persistency when an attacker successfully gain access to a function environment, thereby leaving the reused environment vulnerable to the same attacker access.

Another vulnerability can result from the manipulation of a serverless function's flow. Manipulating the flow can lead to malicious activity, such as remote code execution (RCE), data leaks, and malware injections, and the like.

Another vulnerability is caused due to communications from an interface to a network (e.g., the Internet). Today, developers of serverless functions do not have the ability to provide fine-grain control over network traffic flowing in and out of a software container. For example, developers in an Amazon® cloud environment usually bind a Lambda serverless function to a virtual private cloud (VPC) of Amazon® in order to control the function's network traffic. The network traffic is a suitable solution regarding price, performance (heavy performance degradation), and complexity of operation.

Another vulnerability is caused by use of credentials by functions to access external services. For example, one vulnerability may be caused by utilization of environment variables in order to simplify and abstract function configuration and the use of credentials such that accessing the environment of the function will also allow access to the credentials. The environment variables are provided through an API or user interface, and are utilized during invocation of a function. Sometimes the environment variables are stored in a secure way while on rest. Environment variables are also used to pass the function sensitive information, such as third-party credentials to be used inside the function in order to access APIs of third-party providers, such as Slack, GitHub, Twillo, and the like.

A provider of an FaaS platform can also inject, into the environment, the function credentials that grant access to other services inside the provider cloud (in AWS its IAM credentials). The credentials may be injected using environment variables.

Some providers secure the environment variables at rest or provide temporary credentials. Although these techniques reduce the change of environment variable misuse, utilization of environment variables still poses security risks for the sensitive credentials that are visible inside the function environment. That is, an attacker who gains access to the function environment can leak the credentials and cause real damage to a company even if the credentials are valid for a short period of time (usually 1 hour).

Other vulnerabilities include misconfigured security settings (e.g., web application firewall) and logical vulnerabilities (due to incorrect coding). Such vulnerabilities are difficult to detect because they can appear as regular traffic.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing network security for serverless functions. The method comprises: inspecting, by a reverse proxy, network traffic between a pod and at least one network, wherein the pod is an instance of a software container configured to execute at least one serverless function, wherein each of the at least one serverless function accesses at least one service via the at least one network; detecting a violation of a network profile created for each of the at least one serverless function executed in the pod based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and performing at least one mitigation action when the violation is detected.

Certain embodiments disclosed herein also include a non-transitory computer readable medium having stored thereon causing a processing circuitry to execute a process, the process comprising: inspecting, by a reverse proxy, network traffic between a pod and at least one network, wherein the pod is an instance of a software container configured to execute at least one serverless function, wherein each of the at least one serverless function accesses at least one service via the at least one network; detecting a violation of a network profile created for each of the at least one serverless function executed in the pod based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and performing at least one mitigation action when the violation is detected.

Certain embodiments disclosed herein also include a system for providing network security for serverless functions. The system comprises: a processing circuitry; and a memory, the memory containing instructions that, when executed by the processing circuitry, configure the system to: inspect network traffic between a pod and at least one network, wherein the pod is an instance of a software container configured to execute at least one serverless function, wherein each of the at least one serverless function accesses at least one service via the at least one network; detect a violation of a network profile created for each of the at least one serverless function executed in the pod based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and perform at least one mitigation action when the violation is detected.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a diagram illustrating a function as a service (FaaS) platform providing functions for various services.

FIG. 2 is a diagram illustrating a FaaS platform utilized to describe various disclosed embodiments.

FIGS. 3A-D are diagrams illustrating deployment of a reverse proxy according to various disclosed embodiments.

FIG. 4 is a flowchart illustrating a method for providing network security for serverless functions according to an embodiment.

FIG. 5 is a block diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The embodiments disclosed include techniques for providing cybersecurity for serverless functions. More specifically, the disclosed embodiments provide a traffic inspection security layer for identifying irregular or otherwise malicious activity with respect to execution of remotely executed functions such as serverless functions. In an example embodiment, the traffic inspection security layer is implemented using a reverse proxy configured to intercept and inspect traffic between a serverless function and a network. To this end, the disclosed embodiments also provide techniques for directing traffic to the reverse proxy in order to allow for such inspection.

The disclosed embodiments may be operable in commercially available FaaS platforms supporting various types of serverless functions such as, but not limited to, Amazon® Web Services (AWS) Lambda® functions, Azure® functions, IBM® Cloud functions, and the like. In an embodiment, the traffic inspection security layer is operable in a secured scalable FaaS platform (hereinafter “the scalable FaaS platform”) designed according to at least some embodiments.

In an embodiment, a reverse proxy is deployed in line between one or more pods and a network (e.g., the Internet or an intranet). The pods are software containers configured to execute remotely executed functions (i.e., functions that are called remotely from at least one other portion of code). Input and output (I/O) data sent between one of the pods and an external network (e.g., the Internet or an intranet) are intercepted by the reverse proxy. Based on the intercepted I/O data, the reverse proxy is configured to detect irregularities that may be indicative of malicious behavior. The reverse proxy may further be configured to generate alerts when such irregularities are detected.

The disclosed embodiments further include techniques for enabling remote execution network inspection without controlling the underlying infrastructure. This allows for implementing the reverse proxy without requiring ownership of, for example, the FaaS platform in which the reverse proxy is deployed.

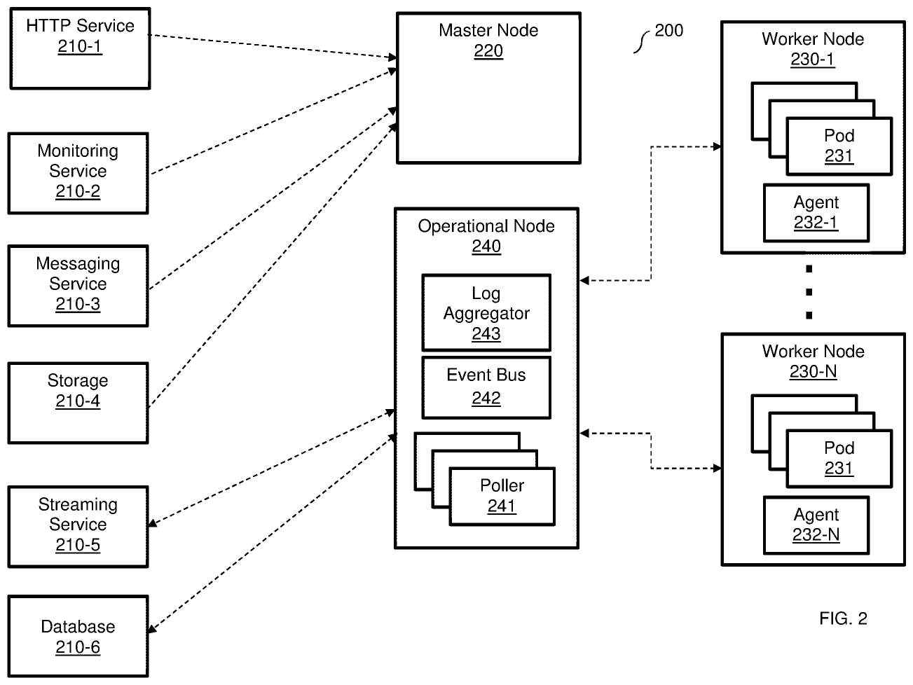

FIG. 2 is an example diagram of a scalable FaaS platform 200 designed according to an embodiment. The scalable FaaS platform 200 is configured to secure execution of serverless functions (hereinafter “functions” or a “function”) by implementing processes of the traffic inspection security layer.

In the scalable FaaS platform 200, software container pods are utilized according to the disclosed embodiments. Each pod is a software container including code for a respective serverless function that acts as a template for each pod associated with that serverless function. When a function is called, it is checked if a pod containing code for the function is available. If no appropriate pod is available, a new instance of the pod is added to allow the shortest possible response time for providing the function. In some configurations, when an active function is migrated to a new FaaS platform, a number of initial pods are re-instantiated on the new platform.

In an embodiment, each request for a function passes to a dedicated pod for the associated function. In some embodiments, each pod only handles one request at a time such that the number of concurrent requests for a function that are being served are equal to the number of running pods. Instances of the same pod may share a common physical memory or a portion of memory, thereby reducing total memory usage.

The pods may be executed in different environments, thereby allowing different types of functions in a FaaS platform to be provided. For example, Amazon® Web Services (AWS) Lambda functions, Azure® functions, and IBM® Cloud functions may be provided using the pods deployed in a FaaS platform as described herein. The functions are services for one or more containerized application platform (e.g., Kubernetes®). A function may trigger other functions.

In addition to the various benefits discussed herein, the disclosed scalable FaaS platform 200 further provides an ephemeral execution environment for each invocation of a serverless function. This ensures that each function's invocation is executed to a clean environment, i.e., without any changes that can occur after beginning execution of the code that can cause unexpected bugs or problems. Further, an ephemeral execution environment is secured to prevent persistency in case an attacker successfully gains access to a function environment.

To provide an ephemeral execution environment, the scalable FaaS platform 200 is configured to prevent any reuse of a container. To this end, the execution environment of a software container (within a pod) is destroyed at the end of the invocation and each new request is served by a new execution environment. This is enabled by keeping pods warm for a predefined period through which new requests are expected to be received.

In an embodiment, the scalable FaaS platform 200 is configured to handle three different types of events that trigger execution of serverless functions. Such types of events include synchronized events, asynchronized events, and polled events. The synchronized events are passed directly to a cloud service to invoke the function in order to minimize latency. The asynchronized events are first queued before invoking a function. The polled events cause an operational node (discussed below) to perform a time loop that will check against a cloud provider service, and if there are any changes in the cloud service, a function is invoked.

In the example embodiment illustrated in FIG. 2, the scalable FaaS platform 200 provides serverless functions to services 210-1 through 210-6 (hereinafter referred to individually as a service 210 or collectively as services 210 for simplicity) through the various nodes 220 through 240. In an embodiment, there are three different types of nodes: master, worker, and operational. In an embodiment, the scalable FaaS platform 200 includes a master node 220, one or more worker nodes 230, and one or more operational nodes 240. In the example implementation shown in FIG. 2, the FaaS platform 200 includes one master node 220, a plurality of worker nodes 230-1 through 230-N (where N is an integer greater than or equal to 2), and one operational node 240.

The master node 220 is configured to orchestrate the operation of the worker nodes 230 and the operational node 240. A worker node 230 includes pods 231 configured to execute serverless functions and may further include a respective agent 232. Each pod 231 is a software container configured to perform a respective function such that any instance of one of the pods 231 contains code for the same function as other instances of the pods 231. The operational node 240 is utilized to run functions for the streaming and database services 210-5 and 210-6. The operational node 240 is further configured to collect logs and data from the worker nodes 230.

Each agent 232 is configured to at least send information related to operation of the pods 231 of the respective worker node 230. Such information may include, but is not limited to, information related to behaviors of serverless functions executed by the pods 231. In particular, such information may include information related to inputs used by the serverless functions and outputs provided by the serverless functions. the information may be sent, for example, to a reverse proxy (e.g., the reverse proxy 310).

The operational node 240 includes one or more pollers 241, an event bus 242, and a log aggregator 243. A poller 241 is configured to delay provisioning of polled events indicating requests for functions. To this end, each poller 241 is configured to perform a time loop and to periodically check an external system (e.g., a system hosting one or more of the services 210) for changes in the state of a resource, e.g., a change in a database entry. When a change in state has occurred, the poller 241 is configured to invoke the function of the respective pod 231.

The event bus 242 is configured to allow communication between the other nodes (i.e., the master node 220 and the worker nodes 230) and the other elements (e.g., the poller 241, log aggregator 243, or both) of the operational node 240.

The log aggregator 243 is configured to collect logs and other reports from the worker nodes 230.

The master node 220 further includes a queue, a scheduler, a load balancer, and an auto-scaler (these components not shown in FIG. 2A), utilized during the scheduling of functions. The autoscaler is configured to scale the pod services according to demand based on events representing requests (e.g., from a kernel, for example a Linux kernel of an operating system). To this end, the autoscaler is configured to increase the number of instances of the pods 231 that are available as needed, while ensuring low latency. For example, when a request for a function that does not have an available pod is received, the autoscaler increases the number of pods. Thus, the autoscaler allows for scaling the platform per request.

The events may include, but are not limited to, synchronized events, asynchronized events, and polled events. The synchronized events may be passed directly to the pods to invoke their respective functions. The asynchronized events may be queued before invoking the respective functions.

It should be noted that, in a typical configuration, there is a small number of master nodes 220 (e.g., 1, 3, or 5 master nodes), and a larger number of worker nodes 230 and operational nodes 240 (e.g., millions). The worker nodes 230 and operational nodes 240 are scaled on demand.

The nodes 220, 230, and 240 may provide a different FaaS environment, thereby allowing for FaaS functions, for example, of different types and formats (e.g., AWS® Lambda, Azure®, and IBM® functions). The communication among the nodes 220 through 240 and the services 210 may be performed over a network, e.g., the internet (not shown in FIG. 2).

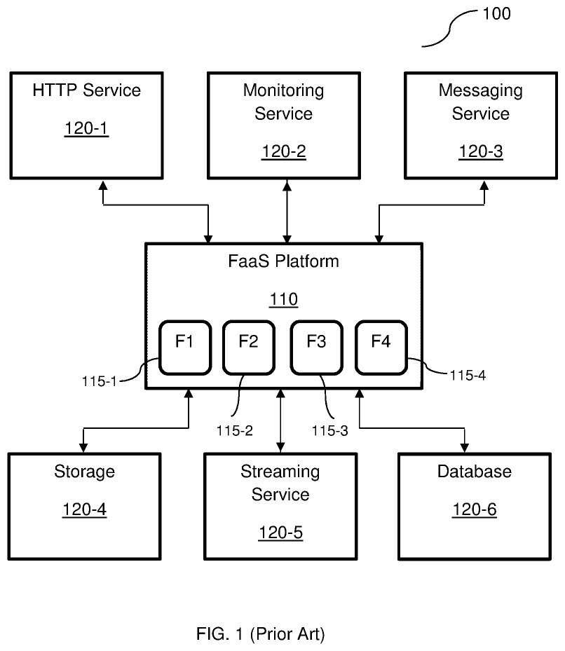

In some implementations, the FaaS platform 200 may allow for seamless migration of functions used by existing customer platforms (e.g., the FaaS platform 110, FIG. 1). The seamless migration may include moving code and configurations to the FaaS platform 200.

It should be noted that the services 210 are merely examples and that more, fewer, or other services may be provided functions by the FaaS platform 210 according to the disclosed embodiments. The services 210 may be hosted in an external platform (e.g., a platform of a cloud service provider utilizing the provided functions in its services). Requests from the services 210 may be delivered via one or more networks (not shown). It should also be noted that the numbers and arrangements of the nodes 211 and the pods 216 are merely illustrative, and that other numbers and arrangements may be equally utilized. In particular, the number of pods 216 may be dynamically changed as discussed herein to allow for scalable provisions of functions.

It should be further noted that, in an example implementation, each of the nodes (shown in FIG. 2) has an underlying hardware layer (not shown in FIG. 2) used to execute the operating system, the pods, load balancers, and other functions.

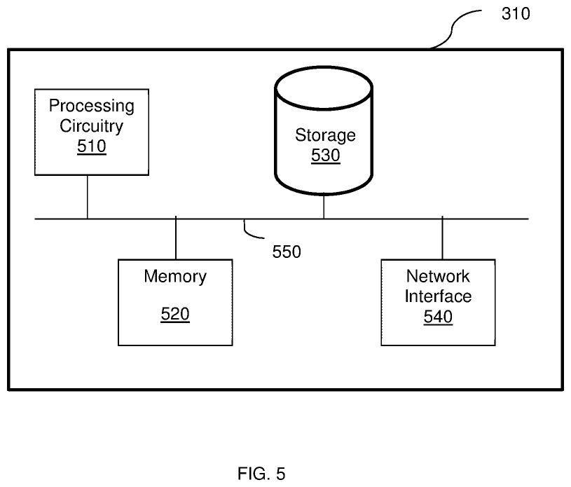

An example block diagram of a hardware layer is described further below with respect to FIG. 5. Furthermore, the various elements of the nodes 220 and 240 (e.g., the scheduler, autoscaler, pollers, event bus, log aggregator, etc.), can be realized as pods. As noted above, a pod is a software container. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). Such Instructions are executed by the hardware layer.

It should be understood that the embodiments described herein are not limited to the specific architecture illustrated in FIG. 2 and that other architectures may be equally used without departing from the scope of the disclosed embodiments. Specifically, the services 210 are merely examples, and that more, fewer, or other services may be provided functions by the FaaS platform 200 according to the disclosed embodiments. The services 210 may be hosted in an external platform (e.g., a platform of a cloud service provider utilizing the provided functions in its services). Requests from the services 210 may be delivered via one or more networks (not shown). It should also be noted that the numbers and arrangements of the nodes and the pods 231 are merely illustrative, and that other numbers and arrangements may be equally utilized. In particular, the number of pods 231 may be dynamically changed as discussed herein to allow for scalable provision of functions.

It should also be noted that the flows of requests shown in FIG. 2 (as indicated by dashed lines with arrows in FIG. 2) are merely examples used to demonstrate various disclosed embodiments and that such flows do not limit the disclosed embodiments.

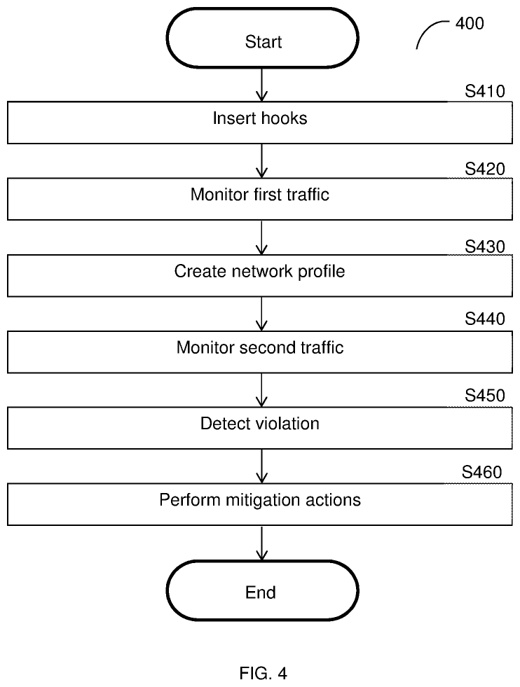

The FaaS platform 200 may be configured to implement traffic inspection security layer to secure the platform 200, executed pods and functions. The traffic inspection security layer is designed to defend against vulnerabilities such as the vulnerabilities discussed above. To this end, in an embodiment, a reverse proxy may be deployed between the FaaS platform 200 and one or more external networks. The reverse proxy at least some of the disclosed embodiments described herein below with respect to FIG. 4.

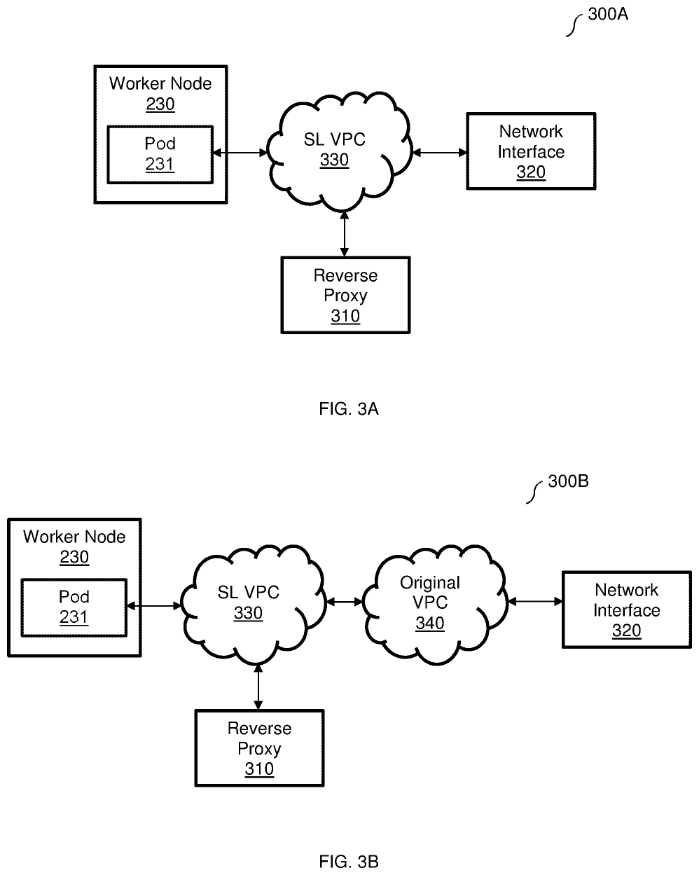

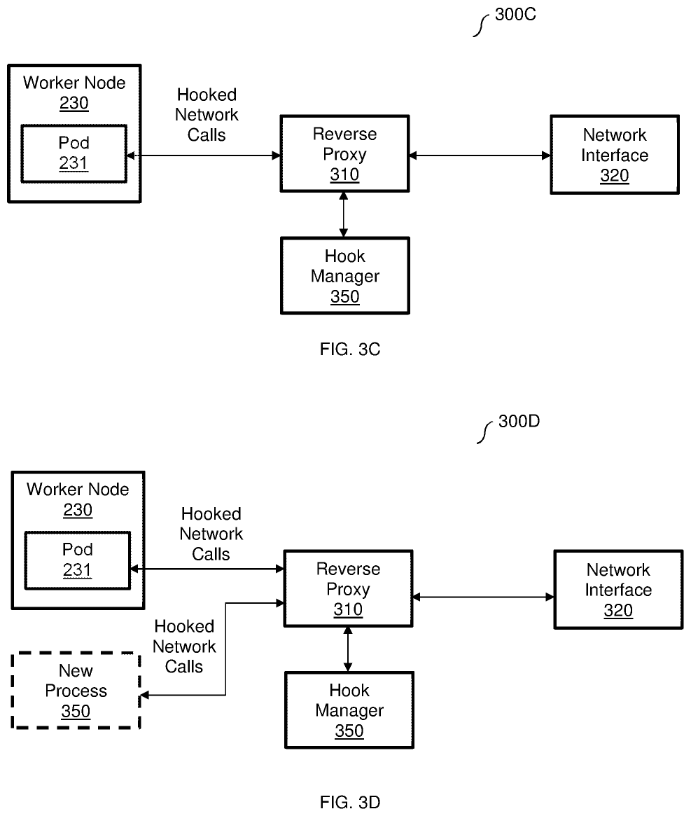

Deployment of the reverse proxy is now described further with respect to FIGS. 3A-D. FIGS. 3A-D are example diagrams 300A-300D, respectively, illustrating deployment of a reverse proxy 310 such that the reverse proxy 310 can intercept traffic between a pod 231 of a worker node 230 and a network interface 320. More specifically, in the example implementations shown in FIGS. 3A-D, the reverse proxy 310 is deployed between the pod 231 and a network interface 320. The network interface 320 provides access to a network (not shown). The network may be, for example, the Internet, an internal service network (i.e., an intranet), and the like. The network interface 320 therefore allows the pod 231 to access services outside of the FaaS platform 200 via the network. In an example implementation, I/O data of the pods 231 is communicated via the network.

The reverse proxy 310 is configured to provide a traffic inspection security layer traffic inspection designed to defend against malicious activity. To this end, the reverse proxy 310 is configured to provide network security for remotely executed functions (e.g., serverless functions provided via the pods 231) in accordance with the disclosed embodiments. In an example implementation, the reverse proxy is implemented as an open systems interconnection (OSI) model layer 4 and layer 7 (i.e., transport and application layers, respectively) proxy that supports all ports and services. It should be noted that layers of the OSI model are not the same as the hardware layer described herein and should not be interpreted as being equivalent. In an embodiment, the reverse proxy 310 includes a hardware layer used for realizing the various embodiments disclosed herein.

In an embodiment, the reverse proxy 310 is configured to inspect traffic communicated through the network interface 320. In a further embodiment, the reverse proxy 310 is further configured to auto-learn function behaviors during a learning period in order to generate rules designed to recognize abnormal or unknown network activities. A set of rules may be generated based on the learned behavior. The rules may be modified by, for example, the user.

In another embodiment, the reverse proxy 310 is further configured to generate alerts when unknown activity is detected. The detection of abnormal or unknown network activities is performed by inspecting for irregularities using machine learning techniques, predefined known malicious patterns, or both.

The reverse proxy 310, operating as a traffic inspection security layer of the FaaS platform 200, is configured to detect SQL/NOSQL injection attacks, block DNS requests, allow traffic on specific ports, inspect data returned to the function, and send a “spark” to an attacker.

As a non-limiting example, a serverless function of the pod 231 can establish a connection with a MySQL database over the network 330 and query the database. This function can be vulnerable to an SQL injection in its outbound data, but can also receive malicious data after a successful query. Accordingly, the reverse proxy 310, acting in accordance with the disclosed embodiments, defends against such SQL injections or receipt of malicious data.

In order to inspect the traffic, the reverse proxy 310 is configured to intercept communications between the pods 231 and the network interface 320 in order to inspect I/O data in such communications and to learn normal serverless function behavior based on the inspection. In particular, such communications may include requests for services. Using the normal learned serverless function behavior and, optionally, predefined malicious behavior, the reverse proxy 310 is configured to identify irregularities in serverless function behavior. When such irregularities are detected, the reverse proxy 310 may be further configured to perform mitigation actions such as, but not limited to, blocking communications with one or more of the pods 231, blocking communications with one or more entities (not shown) communicating via the network, and the like.

In an embodiment, the deployment of the reverse proxy 310 is realized using a security layer virtual private cloud (VPC). Two example implementations of such an embodiment are illustrated in FIGS. 3A-B. More specifically, a security layer (SL) VPC 330 may be deployed in the FaaS platform 200. The SL VPC 330 is configured to redirect traffic coming into or out of the pod 231 to the reverse proxy 310, thereby ensuring that all traffic into or out of the pod 231 is subject to inspection.

FIG. 3A illustrates deployment of the SL VPC 330 when the existing FaaS platform does not include a VPC already. In FIG. 3A, the reverse proxy 310 is configured to forward traffic determined to be regular (i.e., as opposed to irregular, abnormal, or malicious) to its respective destination (i.e., the pod 231 or the network interface 320) after inspection. The SL VPC 330 is deployed in the middle such that traffic can be rerouted to the reverse proxy 310.

FIG. 3B illustrates deployment of the SL VPC 330 when the existing FaaS platform already includes a VPC. In FIG. 3B, the reverse proxy 310 is configured to send traffic determined to be regular (i.e., as opposed to irregular, abnormal, or malicious) to its respective destination (i.e., the pod 231 or the network interface 320). To this end, the SL VPC 330 is deployed in the middle of the pod 231 and an original VPC 340. The original VPC 340 is a preexisting VPC in the FaaS platform 200. The SL VPC 330 therefore connects the reverse proxy 310 to the original VPC 340 for purposes of forwarding traffic to the network interface 320 and for intercepting traffic directed to the pod 231.

In another embodiment, the deployment of the reverse proxy 310 is realized by hooking network calls. Such an implementation is shown in FIGS. 3C-D. This implementation may be used when, for example, the entity implementing the reverse proxy 310 does not have control over the environment in which the SL VPC 330 would be deployed or otherwise is unable to deploy the SL VPC 330.

In FIG. 3C, the reverse proxy 310 is deployed between the pod 231 and the network interface 320 by adding hooks to network calls that redirect traffic to the reverse proxy 310. In an embodiment, the hooks may be added via a hook manager 350. The hook manager 350 may be implemented as, for example, a plugin, a process, a pod, a combination thereof, and the like. The reverse proxy 310 inspects traffic redirected via the hooks as well as incoming traffic from the network interface 320 in order to ensure that no irregularities are detected before allowing the traffic to reach its destination.

It has been identified that the deployment illustrated in FIG. 3C may not capture all traffic generated by the serverless function of the pod 231. As a non-limiting example, if the serverless function creates a new process that generates traffic, requests by the new process may not be captured by the reverse proxy 310. To this end, in a further embodiment, the reverse proxy 310 is further configured to monitor for the creation of new processes and to insert the appropriate network hooks into such new processes. To this end, the reverse proxy 310 may be configured to monitor for the creation of new processes by hooking, at runtime, calls related to the creation of new processes. Such an embodiment is illustrated in FIG. 3D, which further shows a new process 350 communicating with the network interface 320 via the reverse proxy 310.

It should be noted that a single pod 231 is illustrated in FIGS. 3A-D rather than multiple pods or the entire FaaS platform 200 merely for simplicity purposes and without limiting the disclosed embodiments. Likewise, a single network interface 320 is shown merely for simplicity purposes.

Operation of the reverse proxy 310 is now described with respect to FIG. 4. FIG. 4 is an example flowchart 400 illustrating a method for providing network security for serverless functions according to an embodiment. In an embodiment, the method of FIG. 4 may be performed by the reverse proxy 310.

At optional S410, hooks are inserted into a serverless function to be protected. In an embodiment, the hooks redirect any network calls to a reverse proxy (e.g., the reverse proxy 310) deployed between a pod executing the serverless function and a network. In a further embodiment, S410 further includes hooking calls related to creation of sub-processes such that they redirect to the reverse proxy. The reverse proxy may be configured to insert hooks into the sub-process such that network calls of the sub-process also redirect to the reverse proxy.

At S420, first traffic is monitored during a learning period. The monitored traffic includes traffic between the pod (e.g., the pod 231) and a network (e.g., a network accessible via the network interface 320). The traffic includes at least input data used by the pod and output data produced by the pod. The first traffic is intercepted, for example using a VPC configured or hooks as described herein above.

At S430, a network profile is created for the serverless function. The network profile defines a whitelist of normal network behavior of the serverless function such that deviations from the whitelist of normal network behavior may indicate potentially harmful activity. To this end, the network profile at least defines parameters of inputs and outputs of the serverless function of the pod. The inputs and outputs may be inputs received from an external service (i.e., a service accessed by the pod via the network) and outputs sent to the external service. Thus, in an example implementation, the network profile includes a whitelist of allowable inputs and outputs.

In this regard, it is noted that, in cybersecurity, whitelists may be ineffective since they often result in overly restrictive definitions of allowable behaviors (i.e., they will result in excessive false positives). Thus, existing solutions often use blacklists (i.e., impermissible activities) instead of whitelists (i.e., permissible activities). However, it has been identified that remotely executed functions are suitable for effective use of whitelists where other applications would not be. Specifically, since remotely executed functions provide discrete functions, the inputs and outputs of these functions may be clearly defined without requiring consideration of the impacts of other functions. Thus, a whitelist may be accurately defined with respect to these functions.

In an embodiment, S430 may further include learning normal operations of the function and the network profile may include definitions for allowable operations determined based on the normal operations. An example for creating a profile defining allowable operations for a serverless function is described further in U.S. patent application Ser. No. 16/598,349, assigned to the common assignee, the contents of which are hereby incorporated by reference.

In another embodiment, the network profile may further include one or more explicitly defined malicious behaviors. The explicitly defined malicious behaviors may be predetermined, configured by a user, and the like.

At S440, when the network profile for a serverless function is created and ready to use, second traffic between the pod and the network is monitored. The second traffic is intercepted, for example using a virtual private cloud configured or hooks as described herein above.

At S450, a violation of the network profile is detected based on the monitored second traffic. In an embodiment, the detected violation is a deviation from a normal behavior or an occurrence of a malicious behavior defined in the network profile.

At S460, when the violation is detected, one or more mitigation actions is performed.

In the embodiments discussed with reference to FIG. 4, the creation and/or updating of profiles can be performed in parallel to the inspection of traffic. Further, the reverse proxy may be pre-configured with profiles created for the serverless functions executed in a pod. The profiles may be based on same functions executed on a different platform. This would allow to immediately enforce network inspection on the functions. The pre-configured profiles may be updated as functions are being executed.

FIG. 5 is an example block diagram of a hardware layer 500 included in each node according to an embodiment. That is, each of the master node, operational node, and worker node is independently executed over a hardware layer, such as the layer shown in FIG. 5.

The hardware layer 500 includes a processing circuitry 510 coupled to a memory 520, a storage 530, and a network interface 540. In another embodiment, the components of the hardware layer 500 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, configure the processing circuitry 510 to perform the various processes described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the hardware layer 500 to communicate over one or more networks, for example, to receive requests for functions from user devices (not shown) for distribution to software containers (e.g., the pods 231, FIG. 2).

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing network security for serverless functions, comprising:
inspecting, by a reverse proxy, network traffic between a pod and at least one network, wherein the pod is an instance of a software container configured to execute at least one serverless function, wherein each of the at least one serverless function accesses at least one service via the at least one network;
detecting a violation of a network profile created for each of the at least one serverless function executed in the pod based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and
performing at least one mitigation action when the violation is detected.

2. The method of claim 1, further comprising:
monitoring, at the reverse proxy, traffic between the pod and the at least one network;
creating a network profile for each of the at least one serverless function based on the monitored traffic; and
configuring the reverse proxy with the created at least one network profile, wherein the reverse proxy is configured to perform network traffic inspection on the at least one serverless function based on the at least one network profile.

3. The method of claim 1, wherein the network traffic is intercepted by the reverse proxy.

4. The method of claim 3, wherein a virtual private cloud (VPC) is deployed between the reverse proxy and the at least one network, wherein the VPC is configured to redirect traffic to the reverse proxy.

5. The method of claim 4, wherein the VPC is a first VPC, wherein the first VPC is deployed between the pod and a second VPC, wherein the first VPC is configured to redirect traffic to the reverse proxy.

6. The method of claim 3, further comprising:
inserting at least one hook into the at least one serverless function, wherein the at least one hook redirects traffic to the reverse proxy.

7. The method of claim 6, wherein the at least one hook replaces at least one network call.

8. The method of claim 6, wherein at least one of the at least one hook replaces at least one call related to creation of new processes.

9. The method of claim 8, wherein the at least one hook is at least one first hook, further comprising:
monitoring for creation of a new process based on the at least one first hook; and
inserting at least one second hook into the new process, wherein the at least one second hook redirects traffic to the reverse proxy.

10. The method of claim 1, wherein the first traffic and the second traffic each include at least one of: input data, and output data.

11. A non-transitory computer readable medium having stored thereon instructions for causing a processing circuitry to execute a process, the process comprising:
inspecting, by a reverse proxy, network traffic between a pod and at least one network, wherein the pod is an instance of a software container configured to execute at least one serverless function, wherein each of the at least one serverless function accesses at least one service via the at least one network;
detecting a violation of a network profile created for each of the at least one serverless function executed in the pod based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and
performing at least one mitigation action when the violation is detected.

12. A system for providing network security for serverless functions, comprising:
a processing circuitry; and
a memory, the memory containing instructions that, when executed by the processing circuitry, configure the system to:
inspect network traffic between a pod and at least one network, wherein the pod is an instance of a software container configured to execute at least one serverless function, wherein each of the at least one serverless function accesses at least one service via the at least one network;
detect a violation of a network profile created for each of the at least one serverless function executed in the pod based on the inspected second traffic, wherein each network profile defines a whitelist of normal network behavior of the respective serverless function with respect to the at least one service, wherein the normal behavior includes a plurality of properties of normal inputs and normal outputs for the serverless function, wherein the detected violation is a deviation from the whitelist of normal network behavior; and
perform at least one mitigation action when the violation is detected.

13. The system of claim 12, wherein the system is further configured to:
monitor traffic between the pod and the at least one network;
create a network profile for each of the at least one serverless function based on the monitored traffic, wherein the system is configured to perform network traffic inspection on the at least one serverless function based on the at least one network profile.

14. The system of claim 12, wherein the network traffic is intercepted by the system.

15. The system of claim 14, wherein a virtual private cloud (VPC) is deployed between the system and the at least one network, wherein the VPC is configured to redirect traffic to the system.

16. The system of claim 15, wherein the VPC is a first VPC, wherein the first VPC is deployed between the pod and a second VPC, wherein the first VPC is configured to redirect traffic to the system.

17. The system of claim 14, wherein the system is further configured to:
insert at least one hook into the at least one serverless function, wherein the at least one hook redirects traffic to the system.

18. The system of claim 17, wherein the at least one hook replaces at least one network call.

19. The system of claim 17, wherein at least one of the at least one hook replaces at least one call related to creation of new processes.

20. The system of claim 19, wherein the at least one hook is at least one first hook, wherein the system is further configured to:
monitor for creation of a new process based on the at least one first hook; and
insert at least one second hook into the new process, wherein the at least one second hook redirects traffic to the system.

21. The system of claim 12, wherein the first traffic and the second traffic each include at least one of: input data, and output data.
